(19) United States
(12) Patent Application Publication
(10) Pub. No.: US 2005/0231642 A1
(43) Pub. Date: Oct. 20, 2005

(54) Disc jockey audio/video mixer

(75) Inventors: Christopher Roman, Wrentham, MA (US); Brian Shim, Santa Monica, CA (US)

Correspondence Address: BARLOW, JOSEPHS & HOLMES, LTD., 101 DYER STREET, 5TH FLOOR, PROVIDENCE, RI, 02903, US

(73) Assignee: Numark Industries, LLC, Cumberland, RI (US)

(21) Appl. No.: 11/071,948

(22) Filed: Mar. 4, 2005

Related U.S. Application Data
(60) Provisional application No. 60/557,222, filed on Mar. 29, 2004.
(60) Provisional application No. 60/561,590, filed on Apr. 13, 2004.

(51) Int. Cl. H04N 5/222

(52) U.S. Cl. 348/578; 348/515; 348/722

(57) ABSTRACT

An audio/video mixer (10) for disc jockeys includes a number of video inputs (28, 30, 36, 38), a number of audio inputs (24, 26), a video output (46, 48), an audio output (42, 44), and controls (100, 200) thereon for selectively mixing the respective audio and video signals, applying special effects thereto and routing them through the respective video and audio outputs.

### CROSS-REFERENCE TO RELATED APPLICATION

This application claims priority to earlier filed U.S. Provisional Application Ser. No. 60/557,222 filed Mar. 29, 2004, the contents of which are incorporated herein by reference.

### BACKGROUND OF THE INVENTION

The present invention relates generally to disc jockey mixing equipment. In particular, the present invention relates to mixers for audio and also for video.

In the music industry, there is a need for the ability for a disc jockey to mix both audio and video for a given performance. Currently, such capability requires that the disc jockey use separate audio and video mixers. As can be understood, this becomes cumbersome and expensive. Moreover, known audio and video mixers are not meant for operation by disc jockeys and, therefore, are not easily used during a disc jockey performance. For example, the layout and control of known separate audio and video mixers do not have cross-faders and line-faders, which disc jockeys are accustomed to. Also, these mixers do not have a layout that is familiar to disc jockeys.

Therefore, there is a need for audio and video mixing capability in a single piece of equipment that is rugged, rack mountable with familiar disc jockey controls.

### SUMMARY OF THE INVENTION

The present invention provides in a single piece of equipment both audio and video mixing. The mixer of the present invention includes disc-jockey style controls, including a disc-jockey style cross-fader and line-fader. The mixer is rack mountable and rugged, which is important to disc jockeys. The mixer also includes features built-in that are desirable to a disc jockey, such as audio cueing through headphones and digital video effects for video manipulation on the fly.

The audio/video mixer for disc jockeys of the present invention has a main housing with a number of video inputs and a video output. Each video input has a corresponding video signal. The mixer also has a number of audio inputs and an audio output. Each audio input has a corresponding audio signal. The mixer also has a video control on the main housing for selectively mixing any number of the video signals into a mixed video signal and an audio control on the main housing for selectively mixing any number of the audio signals into a mixed audio signal. The mixed video signal is connected to the video output and the mixed audio signal is connected to the audio output.

Accordingly, among the objects of the present invention are the provision for a device for mixing audio and visual signals for disc jockey performances; the provision for a an audio/video mixer that is rugged; the provision for a audio/video mixer that is easily transported; the provision for an audio/video mixer that is rack-mountable; and the provision for an audio/video mixer that is easily used by disc jockeys.

In view of the foregoing, the mixer of the present invention is very compact, dedicated, low-cost and easy-to-use to carry out both audio and video mixing in a single unit which is not found in the prior art.

### BRIEF DESCRIPTION OF THE DRAWINGS

These and other features, aspects, and advantages of the present invention will become better understood with reference to the following description, appended claims, and accompanying drawings where:

FIG. 1 is a perspective view of the preferred embodiment of the present invention;

FIG. 2 is a view of the rear panel of the preferred embodiment of the present invention;

FIG. 3 is a view of the control panel of the preferred embodiment of the present invention; and

FIG. 4 is a conceptual view of the signal processing of the preferred embodiment of the present invention.

### DESCRIPTION OF THE PREFERRED EMBODIMENT

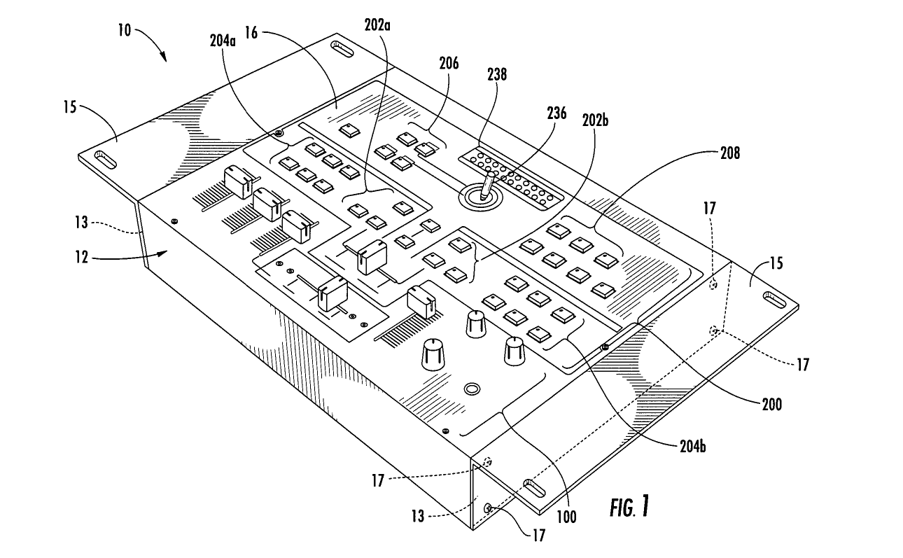

The preferred embodiment of the audio/video mixer for disc jockeys of the present invention is shown generally in FIG. 1-3 at 10. Briefly, the mixer 10 has a main housing 12 having side panels 13, a rear panel 14 and a control panel 16. The mixer 10 has a variety of input and output connectors on the rear panel 14. The mixer 10 also has a variety of controls on the control panel 16 for selectively mixing audio and video signals being inputted through the input connectors on the rear panel 14 and outputting the resulting mixed signal out the output connectors on the rear panel 14. Optionally, rack-mounts 15 could be connected to the side panels 13 by a retainer 17, such as a small screw or bolt, so that the mixer 10 may be mounted within a nineteen-inch rack, which is a standard within the industry.

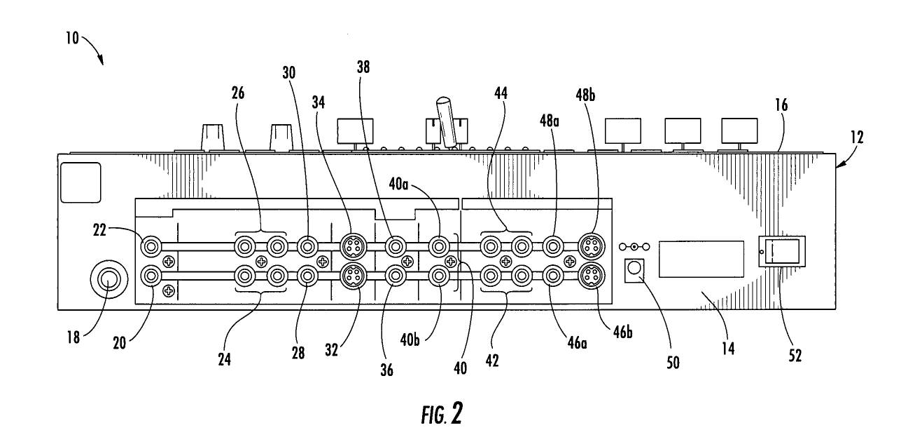

Referring now to FIG. 2, the rear panel 14 of the mixer 10 is shown. The mixer 10 is shown without the rack-mounts 15 attached. The rear panel 14 has a microphone input 18. The microphone input 18 is preferably a quarter inch microphone jack that is a standard within the industry, but other types of microphone jacks known within the art could be used.

Adjacent to the microphone input 18 is a first monitor output 20. The first monitor output 20 is connected to a small video monitor (not shown) for the disc jockey to use during his or her performance to view the unaltered video signal of the first video input described more fully below.

Above the first monitor output 20 is a second monitor output 22 that is identically in operation to the first monitor output 20 with the exception that the second monitor output 22 carries the unaltered video signal of the second video input. The second video input is described more fully below.

Adjacent to the first monitor output 20 are left channel 24a and right channel 24b audio inputs (collectively referred to as the first audio input 24). Although the first audio input 24 described and shown is for stereo sound, surround-sound capability could be added easily to the mixer 10 by incorporating front and rear audio channels.

Above the first audio input 24 is a similarly configured left channel 26a and right channel 26b audio inputs (collectively referred to as the second audio input 26). The second audio input 26 may also be easily configured to handle surround-sound by adding front and rear audio channels.

Adjacent to the audio inputs 24, 26 are four video inputs 28, 30, 32, 34. The first and second video inputs 28, 30 are standard composite video inputs and are typically used by a disc jockey to feed video from industry or consumer model video players such as DVD players, VCRs, or even steaming video from a personal computer. The third and fourth video inputs 32, 34 are S-Video jacks that are standard in the industry for connecting S-Video compatible devices, such as camcorders, to the mixer 10. The disc jockey typically uses the third and fourth video inputs 32, 34 to feed video from live camera feeds to augment his or her performance and to produce unique visual effects when mixed with video form the first and second video inputs 28, 30. These procedures will be described more fully below.

Adjacent to the video inputs 28, 30, 32, 34 is a third monitor output 36. The third monitor output 36 is connected to a small video monitor (not shown) for the disc jockey to use during his or her performance to view the unaltered video signal of the third video input described above.

Above the third monitor output 36 is a fourth monitor output 38 that is identically in operation to the third monitor output 36 with the exception that the fourth monitor output 38 carries the unaltered video signal of the fourth video input described above.

Adjacent to the third and fourth monitor outputs 36, 38 are left 40a and right 40b channel line inputs for audio (collectively referred to as the audio line input 40). The audio line input 40 may be connected to a variety of audio devices such as turntables and CD players to provide the disc jockey with yet another source of audio to use and manipulate during his or her performance. In particular, Numark brand CD players, such as the CDN90, and Numark brand turntables, such as the CDX or TT-series, are particularly well-suited for the disc jockey to use as an additional audio device connected to the line input 40.

Adjacent to the line input 40 are two sets of audio 42, 44 and video 46, 48 outputs. The first set of audio outputs 42 has a left channel 42a and a right channel 42b. Similarly, the second set of audio outputs 44 has a left channel 44a and a right channel 44b also. Like the audio inputs 24, 26, 40, the audio outputs 42, 44 could also be configured with front and rear channels to support surround-sound. Both sets of audio outputs 42, 44 carry the same mixed audio signal described more fully below. Two sets of audio outputs 42, 44 are provided to give the disc jockey flexibility in arranging his or her equipment and in designing his or her performance.

The first set of video outputs 46 has a composite video connector 46a and an S-Video connector 46b. Similarly, the second set of video outputs 48 has a composite video connector 48a and an S-Video connector 48b also. Both the first and second video outputs 46, 48 carry the same mixed video signal described more fully below. The different types of video outputs 46, 48 are provided as a matter of convenience for the disc jockey in order to provide him or her with flexibility in setting up his or her equipment and in planning his or her performance.

Adjacent to the video outputs 46, 48 is a power connector 50. The power connector 50 is a standard 12 volt DC jack that is standard in the industry, but could be another type of connector.

Adjacent to the power connector 50 is a power switch 52, which controls the power to the mixer 10.

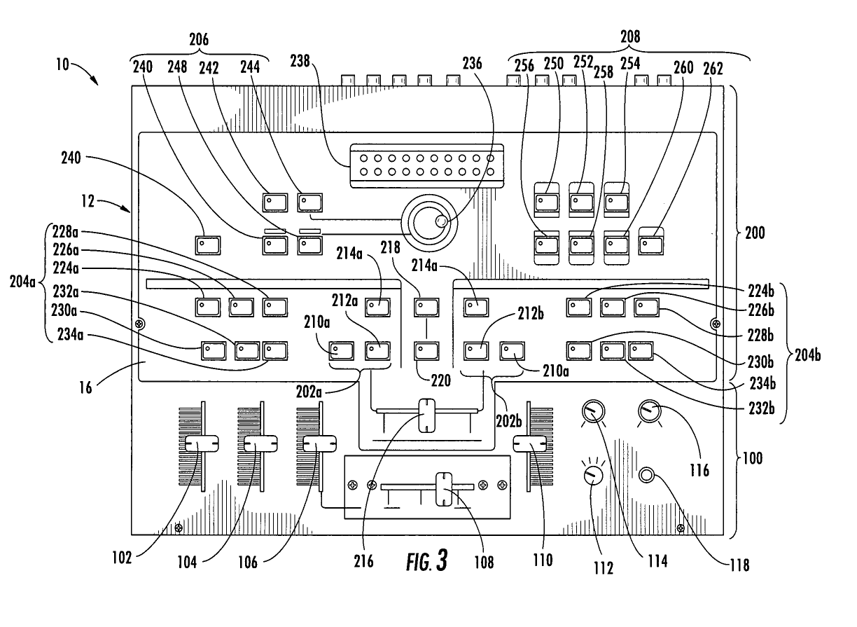

Referring now to FIG. 3, the control panel 16 of the mixer 10 is shown. The mixer 10 is shown without the rack-mounts 15 attached. The control panel 16 is divided generally into two sets of controls: the audio controls 100 and the video controls 200.

The audio controls 100 include a microphone fader 102, line fader 104, audio ½ fader 106, audio cross-fader 108, master audio fader 110, cue source control 112, cue blend control 114, headphone volume control 116, and a headphone output 118.

The faders 102, 104, 106, 110 control the audio volume of the respective outputs 18, 26, 40, 42, 44. Specifically, the microphone fader 102 adjusts the audio level of the microphone input 18; the line fader 104 adjusts the audio level of the audio line input 40; the audio ½ fader 106 controls the overall level for the first audio input 24 and second audio input 26; and the master audio fader 110 controls the overall audio level of the first and second audio outputs 42, 44 of the mixer 10.

The audio cross-fader 108 fades audio between the first audio input 24 and the second audio input 26. Preferably the audio cross-fader 108 is a slidably actuated type control because this type of control is viewed as desirable by disc jockeys. Furthermore, the audio cross-fader 108 should be positioned so that it slides laterally with respect to the control panel 16. A laterally sliding type control is also viewed as a desirable feature in a mixer 10 by disc jockeys. Although laterally sliding type actuators are preferred, other styles of controls would work equally effectively and are well known in the art.

Additionally, the audio cross-fader 108 may be linked to the master video fader 216, which will be described more fully below, so that they operate in tandem. This may be accomplished in many ways. First, both controls 108, 216 could be positioned in similar tracks right next to each other so that the disc jockey may operate both controls 108, 216 simultaneously or by further mechanically coupling the two controls 108 216 together. Another way would be to use a DSP control (not shown) to control both of the faders 108, 216 simultaneously. Activating the DSP control would electrically link the two controls 108, 216 together.

The cue source control 112 selects an audio input 18, 24, 26, 40 to be output through the headphone output 118 in addition to the master audio outputs 42, 44. The headphone output 118 is a standard audio jack used in the industry. The cue blend control 114 fades between the audio output of the master outputs 42, 44 and the source selected by the cue source control 112. The headphone volume control 116 controls the overall volume level being outputted through the headphone output 118.

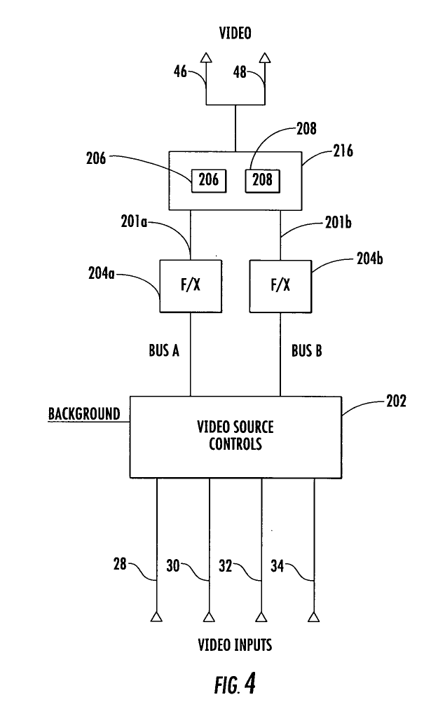

Turning now to the set of video controls 200, the video controls 200 are subdivided into a set of source controls 202, two sets of effects controls 204a, 204b, a set of mode controls 206, and a set of function controls 208. The set of video source controls 202 of the video controls 200 is the centerpiece of the mixer 10. The video source controls 202 are used by the disc jockey to select the video inputs 28, 30, 32, 34 that will ultimately be mixed and outputted through the master video outputs 46, 48. FIG. 4 shows a useful conceptual diagram of the signal processing of the present invention.

The mixer 10 has two video busses, Bus A 201a and Bus B 201b. The video source controls 202 selectively assign the video signals of the video inputs 28, 30, 32, 34 to the desired video bus (Bus A or Bus B) 201a, 201b. The disc jockey may then apply special effects to the selected video signal on the video bus using the effects controls 204a, 204b as desired. The disc jockey may also control how the fade, wipe and picture-in-picture features operate using the mode controls 206 and function controls 208.

The video source controls 202 include the following controls: first video selectors 210a, 210b, second video selectors 212a, 212b, and background selectors 214a, 214b. The video source controls 202 are divided into two sets of controls. Each set is identical to the other with the exception that one set effects the Bus A 102a source and the other set effects the Bus B 102b source. Activating the first video selectors 210a, 210b selects the first video input 28 for the desired video bus to carry. Activating the second video selectors 212a, 212b selects the second video input 30 for the desired video bus to carry. Activating the background selectors 214a, 214b selects the background color set by the background select control 240 (described more fully below). Activating the corresponding first video selector 210a, 210b and corresponding background selector 214a, 214b will set the corresponding video bus to carry the video signal of the third video input 32. Activating the corresponding second video selector 212a, 212b and corresponding background selector 214a, 214b will set the corresponding video bus 201a, 201b to carry the video signal of the fourth video input 34.

Also included are a master video fader 216, auto-fade control 218, and a fade start control 220.

The master video fader 216 fades the video of the master video outputs 34, 36 between the video buses 201a, 201b. Preferably the master video fader 216 is a slidably actuated type control because this type of control is viewed as desirable by disc jockeys. Furthermore, the master video fader 216 should be positioned so that it slides laterally with respect to the control panel 16. A laterally sliding type control is also viewed as a desirable feature in a mixer 10 by disc jockeys. Although laterally sliding type actuators are preferred, other styles of controls would work equally effectively and are well known in the art. As described earlier above, the master video fader 216 may be mechanically or electronically linked to the audio cross-fader control 108.

The auto-fade control 218 and fade start control 220 are used to perform wipes and fades (described more fully below) automatically at the speed selected by the master video fader 216. The auto-fade control 218 turns the auto fade function on and off. The fade start control 220 starts the fade as selected by the master video fader 216.

Adjacent to, and on either side of, the video source controls 202 are two sets of effects controls 204a, 204b. The video effects controls 204a, 204b include activation switches 224a, 224b; invert controls 226a, 226b, still controls 228a, 228b; paint controls 230a, 230b; strobe controls 232a, 232b; and mosaic controls 234a, 234b. The first set of video effects controls 204a applies special effects to video Bus A 201a. The second set of video effects controls 204b applies special effects to video Bus B 201b. The activation switches 224a, 224b toggles the effects on and off. The invert controls 226a, 226b creates a negative of the image on the selected video bus 201a, 201b. The still controls 228a, 228b freezes the image on the selected video bus 201a, 201b. The paint controls 230a, 230b merges shades of colors and forms an abstract picture on the selected video bus 201a, 201b. This function is sometimes called “posterization”. There are three levels of intensity that may be cycled therethrough by activating the controls 230a, 230b repeatedly. The strobe controls 232a, 232b create a “stop action” effect to the selected video bus 201a, 201b. This function 232a, 232b has three speed settings that may be cycled therethrough by repeatedly activating the control 232a, 232b. The mosaic controls 234a, 234b break up the image into patterns of shaded colors to form an abstract picture on the selected video bus 201a, 201b. Three sizes of mosaic squares may be cycled therethrough by activating the mosaic controls 234a, 234b repeatedly.

A joystick 236 is located adjacent to, and above, the auto fade control 218. The joystick 236 is used to position the picture-in-picture window and control the directions of the wipe and fade effects of the mixer 10. These functions will be described more fully below.

Above the joystick 236 is a master audio output meter 238. The master audio output meter indicates the master audio output level as controlled by the master audio fader 110.

Also included is a background select control 240. The background select control 240 selects the background color to be used for the effects. The colors that are included are blue, red, magenta, green, yellow, cyan, white and black. Although conceivably an infinite number of colors could be programmed into the mixer 10, the ones provided for are the most common and desired among disc jockeys. Activating the background select control 240 repeatedly cycles through the available colors.

To the left of the joystick 238 is a set of mode controls 206. The mode controls 206 include a key selector 242, wipe selector 244, mix selector 246, and PIP selector 248. The key selector 242 is used to activate the luma key and blue key functions (described more fully below) during video mixing. The wipe selector 244 toggles between two types of wipes. The first provides a hard edge at the wipe boundary, and the second provides a softer edge at the wipe boundary. The mix selector 246 selects a smooth fade between the video sources selected in Bus A 201a and Bus B 201b. The PIP selector 248 superimposes an image from Bus A 210a over Bus B 201b in a smaller window. This feature is commonly referred to as “picture-in-picture”. The style of the picture-in-picture window may be adjusted with the function controls 208 (described more fully below). The position of the picture-in-picture window may be adjusted with the joystick 238.

To the right of the joystick 238 is a set of function controls 208. The function controls 208 include six function keys 250, 252, 254, 256, 258, 260 and a multi-screen key 262, which augment the mode controls 206 (excepting the mix selector 240, which has no associated functions) by providing different functions, styles and effects to the selected mode controls 206.

When the key selector 242 is activated, there are four active function keys 250, 252, 256, 258. The multi-screen key 262 is not used in this mode. The first function key 250 sets the primary source to Bus A 201a. The second function 252 key sets the primary source to Bus B 201b. The fourth function key 256 replaces blue (pantone 293) areas of the image with a secondary image, at a level controlled by the master video fader 216. This special effect is typically used by news broadcasters in superimposing a weather map behind a weatherman. Two different styles may be cycled through by activating the fourth function key 256 repeatedly. The fifth function key 258 replaces black areas of the image with a secondary image and also progresses to replace lighter shades based on the position of the master video fader 216. Two different styles may be cycled through by repeatedly activating the fifth function key 258,

When the wipe selector 244 is activated, each of the function keys 250, 252, 254, 256, 258, 260 accesses a different style of wipe effect. Each function key 250, 252, 254, 256, 258, 260 also has four sub-functions, which further modify the style of the wipe effect. Activating a particular function key repeatedly cycles through the four sub-functions.

When the PIP selector 248 is activated, each of the function keys 250, 252, 254, 256, 258, 260 accesses a different picture-in-picture style. The first three function keys 250, 252, 254 have picture-in-picture windows with borders. The border color is set to the color selected by the background select control. The last three function keys 256, 258, 260 have picture-in-picture windows lacking borders. The first and fourth function keys 250, 256 provide a picture-in-picture window that is approximately one-half of the image size. The second and fifth function keys 252, 258 provide a picture-in-picture window that is approximately one-quarter of the image size. The third and sixth function keys 254, 260 provide a picture-in-picture window that is approximately one-sixteenth of the image size.

The multi-screen key 262 can only be used in wipe or PIP mode. The multi-screen key 262 will divide the effect into 1, 4, or 16 equal and separate effects.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

1. An audio/video mixer for disc jockeys comprising:
a main housing;
a plurality of video inputs located on the main housing, a plurality of video signals respectively corresponding to the plurality of video inputs;
a plurality of audio inputs located on the main housing, a plurality of audio signals respectively corresponding to the plurality of audio inputs;
a video control on the main housing for selectively mixing the plurality of video signals into a mixed video signal;
an audio control on the main housing for selectively mixing the plurality of audio signals into a mixed audio signal;
a video output connected to the mixed video signal; and
an audio output connected to the mixed audio signal.

2. The mixer of claim 1, further comprising means for applying a digitized video special effect to said mixed video signal.

3. The mixer of claim 1, further comprising:
means for selectively choosing one of said plurality of video signals to be used as a primary source signal;
means for selectively choosing one of said plurality of video signals to be used as a secondary source signal; and
means for super-imposing the secondary source signal over the primary source signal in a picture-in-picture window to form the mixed video signal.

4. The mixer of claim 3, further comprising a joystick for positioning said picture-in-picture window within said primary source signal.

5. The mixer of claim 1, further comprising:
means for selectively choosing one of said plurality of video signals to be used as a first source signal;
means for selectively choosing one of said plurality of video signals to be used as a second source signal; and
means for selectively applying a transition video special effect from said first video signal to said second video signal and vice versa.

6. The mixer of claim 1, further comprising:
means for selectively choosing one of said plurality of video signals to be used as a primary source signal;
means for selectively choosing one of said plurality of video signals to be used as a secondary source signal; and
means for replacing areas of a predetermined color of the primary source signal with the corresponding image of the secondary source signal to form the mixed video signal.

7. An audio/video mixer for disc jockeys comprising:
a main housing;
a plurality of video inputs located on the main housing, a plurality of video signals respectively corresponding to the plurality of video inputs;
a plurality of audio inputs located on the main housing, a plurality of audio signals respectively corresponding to the plurality of audio inputs;
a first video bus located within the main housing and being selectively settable to carry one of said plurality of video signals of the plurality of video inputs;
a second video bus located within the main housing and being selectively settable to carry one of said plurality of video signals of the plurality of video inputs;
a video control on the main housing for selectively mixing the selected video signal on the first video bus and the selected video signal on the second video bus into a mixed video signal;
an audio control on the main housing for selectively mixing the plurality of audio signals into a mixed audio signal; and
a video output connected to the mixed video signal; and
an audio output connected to the mixed audio signal.

8. The mixer of claim 7, further comprising a first means for applying a digital video special effect to the selected video signal of the first video bus.

9. The mixer of claim 8, further comprising a second means for applying a digital video special effect to the selected video signal of the second video bus.

10. The mixer of claim 7, further comprising:
means for selectively choosing between the selected video signal of the first video bus or the selected video signal of the second video bus to be used as a primary source signal;
means for selectively choosing between the selected video signal of the first video bus or the selected video signal of the second video bus to be used as a secondary source signal; and
means for super-imposing the secondary source signal over the primary source signal in a picture-in-picture window to form the mixed video signal.

11. The mixer of claim 7, further comprising a joystick for positioning said picture-in-picture window within said primary source signal.

12. The mixer of claim 7, further comprising means for selectively applying a transition video special effect from the selected video signal of the first video bus to the selected video signal of the second video bus and vice versa.

13. The mixer of claim 7, further comprising:
means for selectively choosing between the selected video signal of the first video bus or the selected video signal of the second video bus to be used as a primary source signal;
means for selectively choosing between the selected video signal of the first video bus or the selected video signal of the second video bus to be used as a secondary source signal; and
means for replacing areas of a predetermined color of the primary source signal with the corresponding image of the secondary source signal to form the mixed video signal.

14. An audio/video mixer for disc jockeys comprising:
a main housing;
a first video input located on the main housing and having a first video signal;
a second video input located on the main housing and having a second video signal;
a third video input located on the main housing and having a third video signal;
a fourth video input located on the main housing and having a fourth video signal;
a first audio input located on the main housing and having a first audio signal;
a second audio input located on the main housing and having a second audio signal;
a first video bus located within the main housing and being selectively settable to carry one of said first video signal, second video signal, third video signal, and fourth video signal;
a second video bus located within the main housing and being selectively settable to carry one of said first video signal, second video signal, third video signal, and fourth video signal;
a video control, located on the main housing, for selectively mixing the selected video signal on the first video bus and the selected video signal on the second video bus into a mixed video signal;
an audio control, located on the main housing, for selectively mixing the first audio signal and the second audio signal into a mixed audio signal;
a video output connected to the mixed video signal; and
an audio output connected to the mixed audio signal.

15. The mixer of claim 14, further comprising a first means for applying a digital video special effect to the selected video signal of the first video bus.

16. The mixer of claim 15, further comprising a second means for applying a digital video special effect to the selected video signal of the second video bus.

17. The mixer of claim 14, further comprising:
means for selectively choosing between the selected video signal of the first video bus or the selected video signal of the second video bus to be used as a primary source signal;
means for selectively choosing between the selected video signal of the first video bus or the selected video signal of the second video bus to be used as a secondary source signal; and
means for super-imposing the secondary source signal over the primary source signal in a picture-in-picture window to form the mixed video signal.

18. The mixer of claim 14, further comprising a joystick for positioning said picture-in-picture window within said primary source signal.

19. The mixer of claim 14, further comprising means for selectively applying a transition video special effect from the selected video signal of the first video bus to the selected video signal of the second video bus and vice versa.

20. The mixer of claim 14, further comprising:
means for selectively choosing between the selected video signal of the first video bus or the selected video signal of the second video bus to be used as a primary source signal;
means for selectively choosing between the selected video signal of the first video bus or the selected video signal of the second video bus to be used as a secondary source signal; and
means for replacing areas of a predetermined color of the primary source signal with the corresponding image of the secondary source signal to form the mixed video signal.
